(19) United States
(12) Patent Application Publication
(10) Pub. No.: US 2026/0052281 A1
(43) Pub. Date: Feb. 19, 2026

(54) SYSTEM AND METHOD FOR BROADCASTING A PERFORMANCE ACTIVITY

(71) Applicant: The University of Hong Kong, Hong Kong (CN)

(72) Inventors: Yaping Zhao, Hong Kong SAR (CN); Edmund Yin Mun Lam, Hong Kong SAR (CN); Rongzhou Chen, Hong Kong SAR (CN)

(21) Appl. No.: 19/293,073

(22) Filed: Aug. 7, 2025

Related U.S. Application Data
(60) Provisional application No. 63/684,567, filed on Aug. 19, 2024.

(51) Int. Cl. H04N 21/2187; G06V 10/26; G06V 20/40; H04N 21/234; H04N 21/4223

(52) U.S. Cl. CPC H04N 21/2187; G06V 10/273; G06V 20/42; G06V 20/44; H04N 21/23418; H04N 21/4223

(57) ABSTRACT

A system for broadcasting a performance activity including at least one event camera focusing on a performance activity scene within a performance activity event, wherein the at least one event camera is adapted to capture event data related to the performance activity scene and transmit an event stream including the event data, a directing system including a processor, a memory unit operatively coupled to the processor, and a user interface operatively coupled to the processor. The at least one event camera is adapted to communicate with the directing system, wherein the directing system is configured to receive the event stream including the captured event data from the at least one event camera. The processor is configured to dynamically identify one or more key gameplay events based on the captured event data, and present the one or more key gameplay events on the user interface.

### TECHNICAL FIELD

The present disclosure relates to a system and method for broadcasting a performance activity. In particular, the present disclosure relates to a system and method for broadcasting an esports event.

### BACKGROUND

Humans perform several performance activities such as sports, dance, esports etc. Several of these performance activities can be recorded and broadcast. Esports is one example of a performance activity that is often broadcast.

Esports (electronic sports) is a form of competition using video games. Esports often takes the form of organised, multiplayer video game competitions, typically between professional video game players. The video game competitions may be played individually or as teams.

Traditional broadcasting technologies for eSports typically fail to capture the rapid and precise movements of players, resulting in broadcasts that lack clarity and detail. This shortfall not only diminishes viewer enjoyment but also limits the effectiveness of these broadcasts for professional analysis and player training.

Traditional sports broadcasts have utilized standard camera technologies, which are often limited by motion blur and inadequate dynamic range, despite the critical importance of capturing human motion in videos. Hilton et al. discuss enhancing sports broadcasts by integrating 3D-TV production from conventional multi-camera setups, emphasizing the challenges in dynamic environments like sports. Furthermore, the comparative analysis by Routhieret al. on temporal versus spatial resolution highlights the limitations of traditional cameras in capturing the fast-paced actions typical in sports.

Advancements in camera technology for sports have focused on overcoming these limitations. Han et al. developed a fast 3-D camera modelling technique for analyzing broadcast court-net sports videos, demonstrating improvements in dynamic camera adaptation. Rosney et al. explored automating sports broadcasts using ultra-high-definition cameras and neural networks, though they noted performance issues due to high computational demands. Additionally, Chen et al. investigated camera selection algorithms specifically for soccer games, addressing the high dynamics of both players and cameras which are critical for effective broadcast.

The integration of augmented reality into sports broadcasting has been explored by Demiris et al., who demonstrated enhanced sports broadcasting capabilities using MPEG-4 for augmented reality. This approach improves viewer engagement by providing enriched visual content. Foote et al. also contributed to this area by developing a touch screen interface for producing live multi-camera sports broadcasts, enhancing the production quality with minimal manual intervention. Recent studies have also examined the subjective and objective quality impacts of HDR in sports broadcasting. Shang et al. focused on assessing video quality in high-dynamic-range sports content, which is crucial for delivering a superior viewer experience in varied lighting conditions.

While these developments have incrementally improved clarity and detail capture, they often involve significant delays in broadcast feeds and require intensive computational resources. Moreover, even with high-frame-rate technology, the problem of inadequate dynamic range remains unresolved, as these cameras still operate under the constraints of conventional frame-based capture mechanisms. These problems can occur when recording and broadcasting performance activities such as esports, dancing, sports e.g., football, badminton etc. This limitation is particularly pronounced in eSports, where player actions can be both rapid and subtle, requiring an innovative approach beyond traditional methodologies.

### SUMMARY

Humans participate in several performance activities such as for example, dancing, sports, esports etc. Esports is one of fastest growing genres of sports or sports entertainment. The rapid growth of esports over the years has created a demand for more dynamic and engaging broadcasts. With an increase in social media and internet apps there is an increasing need for broadcasting performance activities.

The present disclosure is related to a system and method for broadcasting a performance activity or a performance activity event. In particular, the present disclosure is related to a system and method for broadcasting an esports event.

According to a first aspect, there is provided a system for broadcasting a performance activity comprising:
at least one event camera focusing on a performance activity scene within an performance activity event,
wherein the at least one event camera is adapted to capture event data related to the performance activity scene and transmit an event stream comprising the event data,
a directing system comprising a processor, a memory unit operatively coupled to the processor, and a user interface operatively coupled to the processor, the at least one event camera is adapted to communicate with the directing system, wherein the directing system is configured to:
   receive the event stream comprising the captured event data from the at least one event camera,
   the processor is configured to dynamically identify one or more key gameplay events based on the captured event data, and,
   present the one or more key gameplay events on the user interface.

In one example, the performance activity may be esports e.g., an esports event. Alternatively, performance activity may be fitness, sports, dancing or another performance activity. The performance activity may be broadcastable. In one example the performance activity event may be an event of a performance activity e.g., an esports event or esports tournament or a sports event or a fitness event (e.g., powerlifting competition or Crossfit games) or dance performance etc.

In one example the system comprises at least one RGB camera and at least one event camera focusing on the performance activity scene,
wherein the at least one RGB camera is adapted to record a video stream of the performance activity scene, wherein the video stream comprises multiple frames of the performance activity scene and,
the RGB camera further adapted to transmit a video stream comprising the captured frames to the directing system.

In one example, the directing system is adapted to simultaneously receive a video stream from the at least one RGB camera and receive the event stream from the at least one event camera.

In one example, the performance activity event is an esports activity. The esports event may include multiple gameplay events.

The at least one RGB camera and the at least one event camera may be adapted to simultaneously record an esports scene and simultaneously transmit recorded streams to the directing system. The processor i.e., processing unit of the directing system is configured to simultaneously process the received RGB stream (or streams) and the received event stream (or streams).

Unlike traditional cameras, event cameras capture changes in brightness through asynchronous events, thereby providing high temporal resolution and an immense dynamic range without the associated motion blur. The use of event cameras is advantageous because they capture extremely rapid and subtle player movements.

In one example, the system comprises a plurality of RGB cameras and a plurality of event cameras, wherein each RGB camera comprises at least one event camera being mounted on a RGB camera.

In one example the directing system is further configured to: automatically selecting the most relevant key gameplay events from the one or more gameplay events based on the event data.

In one example, the directing system is configured to apply an algorithm specifically designed to identify and extract regions of interest (ROIs) from the received event data which optimizes the broadcast focus on key gameplay events (i.e., critical in-game moments).

In one example, to identify key gameplay events the directing system is configured to:
identify regions of interest (ROI) within the event stream based on the event data,
perform frame reconstruction using the extracted ROI to generate one or more reconstructed frames, and,
crop the reconstructed frames to focus on the ROI.

In one example the ROI is related to hand or finger movements of an esports athlete.

In one example, to identify ROI, the directing system is configured to:
construct or extract an event map from the received event data,
identify regions of highest event density within the event map by summing events within predefined windows,
wherein the identified regions of highest event density correspond to the ROI.

In one example, to identify regions of highest event density the directing system is further configured to:
perform a horizontal scan across each row of the event map,
identify regions with the highest event density by summing events within predefined window widths,
store the indices of the rows with the highest event density,
evaluate vertical slices or columns of the event map corresponding to the stored indices,
determine the columns or vertical slices having the highest event density,
identify an ROI that corresponds to a horizontal window and a vertical slice or column that comprise the highest event density.

In one example the directing system is configured to broadcast a stream of the esports event wherein the stream wherein the stream automatically switches between multiple RGB camera streams and the most relevant key gameplay events.

In one example the directing system is configured to:
present the cropped frame focusing on the ROI on the user interface and/or,
generate a stream of the esports event and switch the stream to focus on the ROI.

In one example, the directing system may be an automated directing (or production) system that is configured to generate and broadcast a video stream (i.e., a broadcast stream) of the esports event. The broadcast stream may be a video stream.

Optionally, the directing system may be further configured to automatically and dynamically select camera regions of interest based on event data. The directing system may be configured to switch between camera streams of multiple RGB cameras and switch to display specific ROI (regions of interest) based on the event data. The directing system may be adapted to automatically control a switcher to switch between camera streams and focus on specific ROI within camera streams.

In one example, the directing system comprises a switcher (i.e., switching apparatus) that is operatively coupled to each event camera and each RGB camera, the switcher is operatively coupled to the processor and the switcher may be controlled to switch the broadcast stream to focus on the stream from a RGB camera or an ROI.

The system may further comprise one or more microphones to capture sounds from the esports event. The switcher may be operatively coupled to each microphone and the directing system may be configured to receive the captured audio and include the audio into the broadcast stream.

Optionally, the directing system may comprise a communication module or a communications link that is configured to allow the directing system to connect to a communication network such as for example a cellular network or a Wi-Fi network.

Alternatively, the directing system may allow a producer to manually switch camera feeds within the stream manually. In this example, a producer or director (i.e., a person) may manually control a switcher to switch between various camera streams and focus in on specific ROI.

In one example the RGB camera may be any video camera capable of capturing color video. For example, the RGB camera may be a high-definition digital camera or DSLR camera or any camera suitable for capturing video.

Optionally, the directing system is configured to present the one or more key gameplay events on the user interface. A director or producer can view the key gameplay events on the user interface and control the switcher to switch the feed to a corresponding camera to display gameplay events in the broadcast stream.

According to a second aspect there is provided, a computer-implemented method for broadcasting an esports event, comprising the steps of:
receiving the event stream comprising the captured event data from the at least one event camera,
receiving a recorded video stream from at least one RGB camera, wherein the video stream comprises multiple frames of the esports scene,
dynamically identifying one or more key gameplay events based on the captured event data, and,
presenting the one or more key gameplay events on the user interface.

In one example, the method comprises receiving video streams from a plurality of RGB cameras and event streams from a plurality of event cameras, wherein each RGB camera comprises at least one event camera being mounted on a RGB camera.

In one example the steps of receiving the event stream and receiving the RGB stream may occur simultaneously. In one example the at least one RGB camera and the at least one event camera may simultaneously record and transmit streams of an esports scene.

In one example, the method for broadcasting an esports event may be used for broadcasting a performance activity such as for example, an esports or dancing or sports or fitness activity etc.

In one example the method comprises automatically selecting the most relevant key gameplay events from the one or more gameplay events based on the event data.

In one example, the method comprises applying an algorithm specifically designed to identify and extract regions of interest (ROIs) from the received event data which optimizes the broadcast focus on key gameplay events (i.e., critical in-game moments).

In one example, the step of identifying key gameplay events comprises:
identifying regions of interest (ROI) within the event stream based on the event data,
performing frame reconstruction using the extracted ROI to generate one or more reconstructed frames, and,
cropping the reconstructed frames to focus on the ROI.

In one example the ROI is related to hand or finger movements of an esports athlete.

In one example, the step of identifying ROI comprises:
constructing or extracting an event map from the received event data,
identifying regions of highest event density within the event map by summing events within predefined windows,
wherein the identified regions of highest event density correspond to the ROI.

In one example, the step of identifying regions of highest event density comprises:
performing a horizontal scan across each row of the event map,
identifying regions with the highest event density by summing events within predefined window widths,
storing the indices of the rows with the highest event density,
evaluating vertical slices or columns of the event map corresponding to the stored indices,
determining the columns or vertical slices having the highest event density, and
identifying an ROI that corresponds to a horizontal window and a vertical slice or column that comprise the highest event density.

In one example, the method comprises broadcasting a stream of the esports event. Optionally the step comprises automatically switching between multiple RGB camera streams and the most relevant key gameplay events.

In one example the directing system is configured to:
present the cropped frame focusing on the ROI on the user interface and/or,
generate a stream of the esports event and switch the stream to focus on the ROI.

Optionally, the method comprises generating and broadcasting a video stream of the esports event. The stream may be a video stream. The method may further comprise automatically and dynamically selecting camera regions of interest based on event data. The method may comprise the steps of switching between camera streams of multiple RGB cameras and switching to display specific ROI (regions of interest) based on the event data. The method may comprise automatically controlling a switcher to switch between camera streams and focus on specific ROI within camera streams.

The method described above may be stored as computer readable and executable instructions that, in use may be executed by the processor (or processing unit) of the directing system.

According to a further aspect, there is provided a data processing system for broadcasting an esports event comprising means for carrying out the method of any one of statements as described above.

According to a further aspect there is provided, a computer program comprising instructions which, when the program is executed by a computer, cause the computer to carry out the method of any one of the statements described above or herein.

According to a further aspect, there is provided a computer-readable medium comprising instructions which, when executed by a computer, cause the computer to carry out the method as per any one of the statements described above or herein.

According to a further aspect, there is provided a system for broadcasting an esports event comprising:
at least one event camera focusing on an esports scene within an esports event, wherein the at least one event camera is adapted to capture event data related to the esports scene and transmit an event stream comprising the event data,
at least one RGB camera and at least one event camera focusing on the esports scene, wherein the at least one RGB camera is adapted to record a video stream of the esports scene, wherein the video stream comprises multiple frames of the esports scene and,
a switcher operatively coupled to the at least one event camera and the at least one RGB camera and the at least one event camera,
a directing system comprising a processor, a memory unit operatively coupled to the processor, and a user interface operatively coupled to the processor, the at least one event camera is adapted to communicate with the directing system,
the directing system is further operatively coupled to the switcher and configured to control the switcher,
wherein the directing system is configured to:
   receive the event stream comprising the captured event data from the at least one event camera,
   receive captured video including a plurality of captured frames from the at least one RGB camera,
   the processor is configured to dynamically identify one or more key gameplay events based on the captured event data, and,
   generate a broadcast stream comprising the video stream from the at least one RGB camera and/or the event data from the at least one event camera,
   control the switcher to switch to a RGB camera and/or event camera that corresponds to the identified key gameplay events such that the broadcast stream is focused on the identified key gameplay events.

Optionally, the directing system is configured to present the one or more key gameplay events on the user interface. A director or producer can view the key gameplay events on the user interface and control the switcher to switch the feed to a corresponding camera to display gameplay events in the broadcast stream.

According to a further aspect there is provided, a computer implemented method for broadcasting an esports event, comprising the steps of:
receiving an event stream comprising event data from at least one event camera positioned to capture an esports event scene,
receiving a video stream comprising frames from one or more RGB cameras,
wherein the event and the video stream are simultaneously received,
extracting frames from the video stream,
identifying regions of interest (ROI) based on the event data corresponding to one or more gameplay actions within the received stream of events,
dynamically selecting the regions of interest (ROI), wherein each ROI corresponds to a key gameplay event,
receiving captured audio from one or more microphones
broadcasting a broadcast stream of the esports event, wherein the broadcast stream comprises a video stream with incorporated audio from the microphones and the event data and the identified regions of interest.

In one example the received video stream or streams, and the received event stream or streams are simultaneously processed to identify the ROI and dynamically select ROI.

According to a further aspect, there is provided an automated directing system for directing or controlling a broadcast stream, wherein the system is configured to:
automatically direct broadcasts using data from at least one event camera,
dynamically select camera regions of interest based on the event data, wherein the regions of interest (ROI) correspond to one or more key gameplay events.

According to a further aspect, there is provided a region of interest (ROI) extraction method (or algorithm), comprising the steps of:
identifying one or more ROI based on received event data from at least one event camera,
incorporating the ROI into a broadcast stream.

The term “comprising” (and its grammatical variations) as used herein are used in the inclusive sense of “having” or “including” and not in the sense of “consisting only of”.

It is to be understood that, if any prior art information is referred to herein, such reference does not constitute an admission that the information forms a part of the common general knowledge in the art, in any country.

### BRIEF DESCRIPTION OF THE DRAWINGS

Embodiments of the present disclosure will now be described, by way of example, with reference to the accompanying drawings in which:

FIG. 1 is an example system for broadcasting esports in accordance with one embodiment of the present disclosure;

FIG. 2 illustrates an example real world set up of a system for broadcasting esports being used to capture an esports event.

FIG. 3 illustrates an example set up of an event camera being mounted on an RGB camera.

FIG. 4 illustrates a schematic diagram of a computing apparatus which is arranged to be implemented as an example embodiment of a directing system.

FIG. 5 illustrates a method of broadcasting an esports event.

FIG. 6 illustrates a flow diagram of the workflow for a method of identifying key gameplay events.

FIG. 7 illustrates a practical example of the frame reconstruction process that is used in the method for identifying key gameplay events.

FIG. 8 illustrates a frame captured by an RGB camera of an esports scene and an event data captured by an event camera of the same esports scene.

FIG. 9 illustrates three different esports scenes from a stored dataset, wherein the frames from an RGB camera and the event data from an event camera are captured.

FIG. 10 illustrate the reconstructed frames and improvement in clarity and quality due to reconstructions.

FIG. 11 illustrate the reconstructed frames and improvement in clarity and quality due to reconstructions.

FIG. 12 illustrate the reconstructed frames and improvement in clarity and quality due to reconstructions.

FIG. 13 illustrates reconstructed frames for a dance activity.

### DETAILED DESCRIPTION

The rapid growth of eSports has created a demand for more dynamic and engaging broadcasting techniques. Traditional broadcasts, reliant on standard RGB cameras, often fall short in capturing the intricate details of eSports competitions, particularly the fast, precise hand movements of professional gamers. These subtle actions, crucial for a comprehensive understanding and enjoyment of the game, typically occur at speeds that surpass the capturing capabilities of conventional video technology, leading to a gap in what viewers can experience and appreciate during live streams or replays. The rapid and coordinated hand movements in eSports highlight the need for advanced capturing technologies to fully convey the players' behavioral decisions and control mechanisms. Enhancing the viewer experience in eSports broadcasting is not merely a matter of entertainment value but is pivotal for the sports growth, audience retention, and educational outreach. The challenge lies in the inherent limitations of traditional broadcast technology, which struggles with low temporal resolution and high motion blur. These technological shortcomings prevent a detailed, clear depiction of quick, minute actions, crucial in fast-paced eSports environments.

Additionally, the dynamic range of standard cameras often inadequately handles the varied lighting conditions typical in eSports arenas, leading to over or underexposed footage, further diminishing the broadcast quality. Historically, advancements in sports broadcasting have attempted to address these issues through high-frame-rate cameras and enhanced post-production techniques. While these developments have incrementally improved clarity and detail capture, they often involve significant delays in broadcast feeds and require intensive computational resources. Moreover, even with high-frame-rate technology, the problem of inadequate dynamic range remains unresolved, as these cameras still operate under the constraints of conventional frame-based capture mechanisms. Similar limitations as above can occur when attempting to broadcast performance activities such as dancing, fitness, sports and esports. This limitation is particularly pronounced in eSports, where player actions can be both rapid and subtle, requiring an innovative approach beyond traditional methodologies.

The present disclosure relates to a system and method for broadcasting a performance activity. In particular, the present disclosure relates to a system and method for broadcasting an esports event.

In one example, there is provided a system for broadcasting a performance activity comprising: at least one event camera focusing on a performance activity scene within an performance activity event, wherein the at least one event camera is adapted to capture event data related to the performance activity scene and transmit an event stream comprising the event data, a directing system comprising a processor, a memory unit operatively coupled to the processor, and a user interface operatively coupled to the processor, the at least one event camera is adapted to communicate with the directing system, wherein the directing system is configured to: receive the event stream comprising the captured event data from the at least one event camera, the processor is configured to dynamically identify one or more key gameplay events based on the captured event data, and, present the one or more key gameplay events on the user interface.

In one example, the present disclosure relates to a system and method for broadcasting an esports event. The following disclosure of a system and method will be described in the context of broadcasting an esports event.

In one example the system for broadcasting an esports event comprises one or more event cameras configured for capturing high speed movements and fine motor movements of players participating in esports events. The event cameras that capture more detailed and dynamic visual content. The present disclosure relates to the use and application of event cameras as part of a system for broadcasting an esports event.

The present disclosure also relates to an automated directing system that is configured to automatically direct broadcasts using data from on or more cameras capturing esports events. The directing system is configured to automatically select camera regions of interest based on event data from the one or more cameras. The directing system may be part of the system for broadcasting an esports event. This system allows for automated, real-time directing of broadcasts by dynamically selecting and showcasing the most relevant in-game actions. The one or more cameras may comprise at least one event camera.

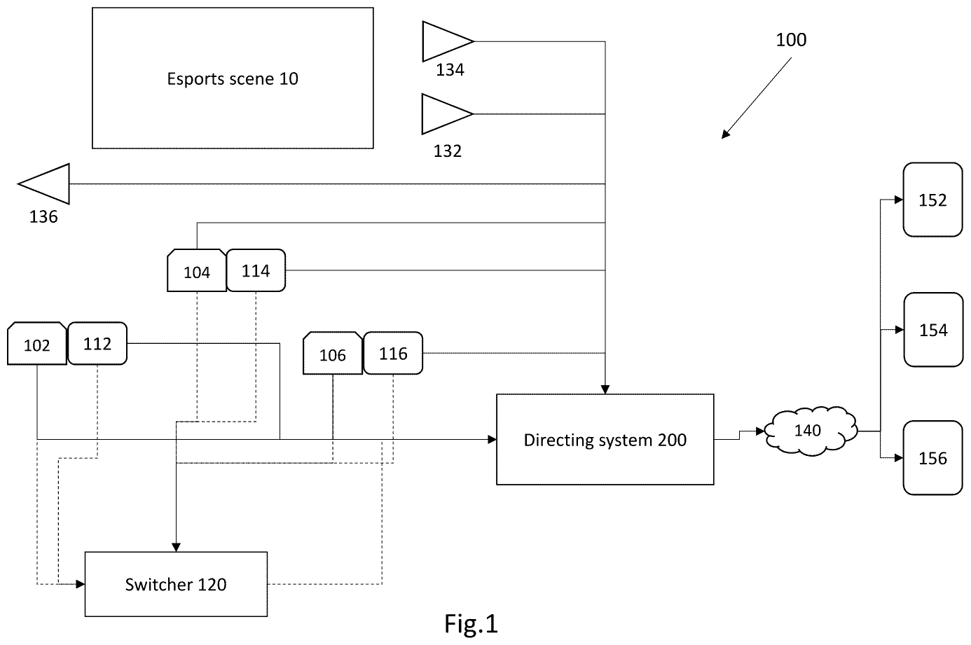

Referring to FIG. 1, an embodiment of the present disclosure is illustrated. This embodiment is arranged to provide a system 100 for broadcasting an esports event comprising: at least one event camera 102 focusing on an esports scene 10 within an esports event, wherein the at least one event camera 102 is adapted to capture event data related to the esports scene and transmit an event stream comprising the event data, a directing system 200 comprising a processor 202, a memory unit 204 operatively coupled to the processor, and a user interface 212 operatively coupled to the processor, the at least one event camera 102 is adapted to communicate with the directing system, wherein the directing system 200 is configured to: receive the event stream comprising the captured event data from the at least one event camera, the processor is configured to dynamically identify one or more key gameplay events based on the captured event data, and, present the one or more key gameplay events on the user interface 212.

In one example the system comprises at least one RGB camera 112 and at least one event camera 102 focusing on the esports scene, wherein the at least one RGB camera is adapted to record a video stream of the esports scene, wherein the video stream comprises multiple frames of the esports scene and, and the RGB camera further adapted to transmit a video stream comprising the captured frames to the directing system.

In one example to identify key gameplay events the directing system 200 is configured to: identify regions of interest (ROI) within the event stream based on the event data, perform frame reconstruction using the extracted ROI to generate one or more reconstructed frames, and crop the reconstructed frames to focus on the ROI.

Referring to FIG. 1, the system 100 may comprise a plurality of cameras. For example, the system 100 may comprise a plurality of event cameras 102, 104, 106 and a plurality of RGB cameras 112, 114, 116. Each camera is adapted to focus on and capture an esports scene within an esports event. The event cameras 102-106 are each adapted to capture event data related to the esports scene 10 and transmit an event stream comprising the event data. Each RGB camera 112-116 is adapted to capture a video stream, preferably a color video stream of the esports scene 10 of the esports event. The RGB camera may comprise any suitable video camera such as for example, a high definition (HD) digital camera or DSLR camera or any camera suitable for capturing video.

The system 100 comprises a directing system 100. The directing system 200 is configured to receive the event stream from the event cameras 102-106 and receive the recorded video stream from the RGB cameras 112-116. The directing system 100 is configured to: receive the event stream comprising the captured event data from the at least one event camera, the processor is configured to dynamically identify one or more key gameplay events based on the captured event data and present the one or more key gameplay events on the user interface. The directing system 200 may also create and transmit a stream of the esports event.

As shown in FIG. 1, the system 100 may comprise a plurality of RGB cameras and a plurality of event cameras. Each RGB camera 112-116 comprises at least one event camera being mounted on or adjacent the RGB camera.

The system 100 may comprise a user interface 212. The interface 212 may be part of the directing system 200 or may be a separate element that is operatively coupled to the directing system 200. The user interface 212 may display one or more of the received streams from the RGB cameras 112-116 and/or event cameras 102-106. The user interface 212 may be an LCD screen, LED screen or other screen. The interface 212 may be touchscreen. Displaying the recorded streams allows a director or producer to make production decisions and select specific cameras to focus on and stream as part of the broadcast.

The system 100 may optionally comprise a switcher 120 that is operatively coupled event cameras 102-106 and the RGB cameras 112-116. The switcher 120 also be operatively coupled to the directing system 200 or may be part of the directing system 200. The switcher may be configured to select or switch between the various camera streams i.e., camera feeds. The switcher allows a director or producer to select a specific camera feed thereby allowing the director to control the broadcast. The switcher 120 may be an automated switcher controlled by the processor of the directing system 200 and may automatically select a particular camera feed.

The system 100 for broadcasting an esports event may also comprise one or more additional microphones. The microphones 132-136 may be positioned at appropriate locations to capture sounds of the esports event. The outputs of the microphones may be directly fed into the directing system 200 or may be fed through the switcher to the directing system 100. The directing system 200 may be configured to incorporate the captured sounds from the microphones 132-136 into the broadcast stream. A director may selectively choose a particular microphone to use or engage via the switcher 120 or directing system 200.

The directing system 200 may be configured to broadcast the esports event. More specifically, the directing system 200 is configured to stream a video of the esports event and esports scene via a network 140 to one or more viewer devices 152-156 such as for example smartphones, tablets, laptops etc. The directing system 200 may comprise a streaming server that allows the viewer devices 152-156 to connect with via the network 140 and operate as client devices to access and view the stream of the esports event.

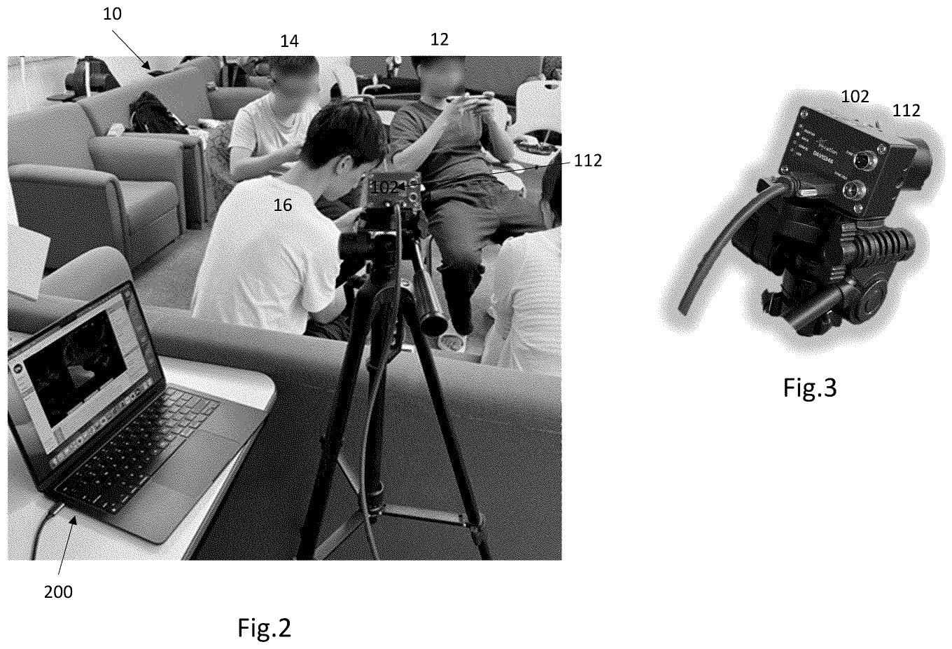

FIG. 2 illustrates an example application of system 100 being used to capture an esports event. The esports scene 10 in FIG. 2, includes players 12, 14 and 16 each playing mobile games. The system 100 comprises one RGB camera 112 and one event camera 102 are used to capture an esports scene 10. The system 100 further comprises a directing system 200, and the cameras 112, 102 are operatively coupled to the directing system 200. In the illustrated embodiment the directing system 200 comprises a laptop but may be in the form of a desktop, smartphone, or tablet or other computing apparatus. The directing system 200 is preferably a computing apparatus. FIG. 3 illustrates an example of the interaction of the RGB camera and the event camera. The system 100 may comprise an event camera 102 that is mounted on or adjacent the RGB camera, or as shown in FIG. 3, the event camera 102 is integrated with the RGB camera 112 into a single unit device or housing. Alternatively, in some other example implementations, the event camera may also be bolted to or coupled to or adhered to a separate RGB camera.

As illustrated in Table 1 below, event cameras offer several advantages over traditional camera systems. These advantages are particularly valuable in fields requiring high temporal resolution and HDR, yet without the drawbacks of cost and computational demands. Event cameras can effectively capture detailed motion in imaging systems.

The asynchronous nature of data capture in event cameras allows for capturing more detailed motion without the blur typically associated with rapid movements. The system 100 applies event cameras specifically for eSports, an area that demands an exceptionally high level of detail and responsiveness. The use of event cameras is advantageous because they are low cost, low latency and a high dynamic range. Event cameras can capture find motor movements and rapid movements.

TABLE 1
Comparison of different cameras. Event cameras offer advantages
in terms of cost, latency, and dynamic range relative
to low-speed and high-speed traditional cameras.

| | Low-speed | High-speed | Event |
|---|---|---|---|
| Type | camera | camera | camera |
| Low cost | ✓ | X | ✓ |
| Low latency | X | ✓ | ✓ |
| HDR | X | X | ✓ |

In this example embodiment, the directing system 200 may be implemented by a computing apparatus having an appropriate user interface. The directing system 200 may be implemented by any computing architecture, including portable computers, tablet computers, stand-alone Personal Computers (PCs), smart devices, Internet of Things (IOT) devices, edge computing devices, client/server architecture, “dumb” terminal/mainframe architecture, cloud-computing based architecture, or any other appropriate architecture. The computing device may be appropriately programmed to implement a method of broadcasting an event e.g., an esports event as described herein. The computing device may be appropriately programmed to function as a system or as part of a system for broadcasting an event of performance activities.

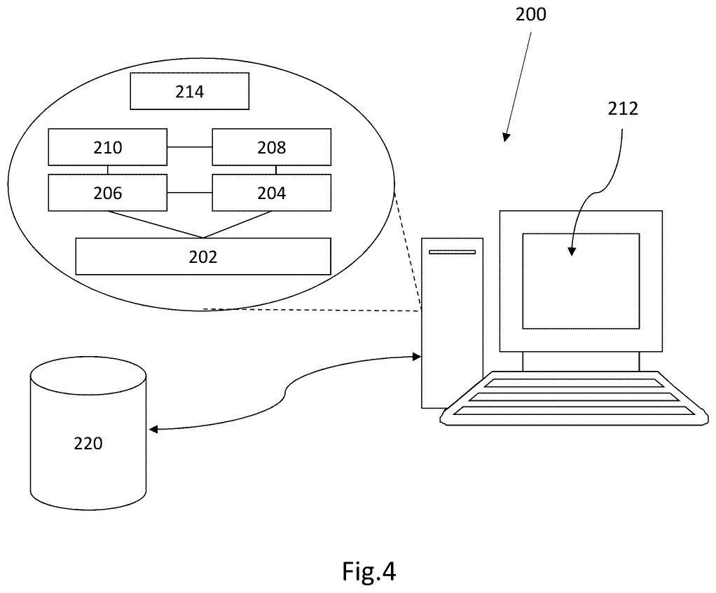

As shown in FIG. 4 there is a shown a schematic diagram of a computing apparatus or computer server which is arranged to be implemented as an example embodiment of a directing system 200 that is used as part of the system 100 for broadcasting an esports event. In this embodiment the directing system 200 includes suitable components necessary to receive, store and execute appropriate computer instructions. The directing system 200 comprises components and software to perform one or more video directing functions and functions to transmit a video or stream of an esports scene. In one example, the directing system comprises components that may include a processing unit (i.e., processor) 202, including Central Processing Unit (CPU), Math Co-Processing Unit (Math Processor), Graphic Processing Unit (GPUs) or Tensor processing unit (TPUs) for tensor or multi-dimensional array calculations or manipulation operations.

The directing system 200 i.e., computing apparatus further comprises a memory unit adapted to store received information such as for example received video streams or event streams, received from the RGB cameras and the event cameras respectively. In one example the apparatus comprises, read-only memory (ROM) 204, random access memory (RAM) 206, and input/output devices such as disk drives 208, input devices 210 such as an Ethernet port, a USB port, etc. The directing system 200 may comprise a user interface 212. The user interface may comprise display 212 such as a liquid crystal display, a light emitting display or any other suitable display and communications links 214.

The computing apparatus i.e., directing system 200 may include instructions that may be included in ROM 204, RAM 206 or disk drives 208 and may be executed by the processing unit (i.e., processor) 202. There may be provided a plurality of communication links 214 which may variously connect to one or more computing devices such as a server, personal computers, terminals, wireless or handheld computing devices, Internet of Things (IoT) devices, smart devices, edge computing devices. At least one of a plurality of communications link may be connected to an external computing network through a telephone line or other type of communications link. The communication link 214 may be communication module that allows the directing system 200 to connect to a communication network e.g., Wi-Fi or Cellular network. The communication link 214 allows the system 200 to transmit or broadcast a recorded stream of the esports event.

The computing apparatus 200 (i.e., directing system) may include storage devices such as a disk drive 208 which may encompass solid state drives, hard disk drives, optical drives, magnetic tape drives or remote or cloud-based storage devices. The directing system 200 may use a single disk drive or multiple disk drives, or a remote storage service. The directing system 200 may also have a suitable operating system which resides on the disk drive or in the ROM of the computing apparatus 200 (i.e., directing system).

The computing apparatus may further comprise one or more databases 220 adapted to store one or more pieces of data. The database 220 may be used to store recorded video streams from the RGB cameras and event streams from the event cameras.

The directing system 200 or computing apparatus may also provide the necessary computational capabilities to operate or to interface with a machine learning network, such as a neural networks, to provide various functions and outputs. The neural network may be implemented locally, or it may also be accessible or partially accessible via a server or cloud-based service. The machine learning network may also be untrained, partially trained or fully trained, and/or may also be retrained, adapted or updated over time. The computing apparatus may comprise one or more GPUs being operatively coupled to the CPU (i.e., processor). The computing apparatus may comprise additional hardware elements operatively coupled to the CPU and/or the GPU to provide the computing apparatus components needed to implement a machine learning network or machine learning model. The learning network or model may be stored in a memory unit e.g., ROM.

The system 100 is designed to capture detailed hand movements of eSports athletes, crucial for analysing and broadcasting their fine motor skills. This is possible due to the use of event cameras in addition to the RGB cameras.

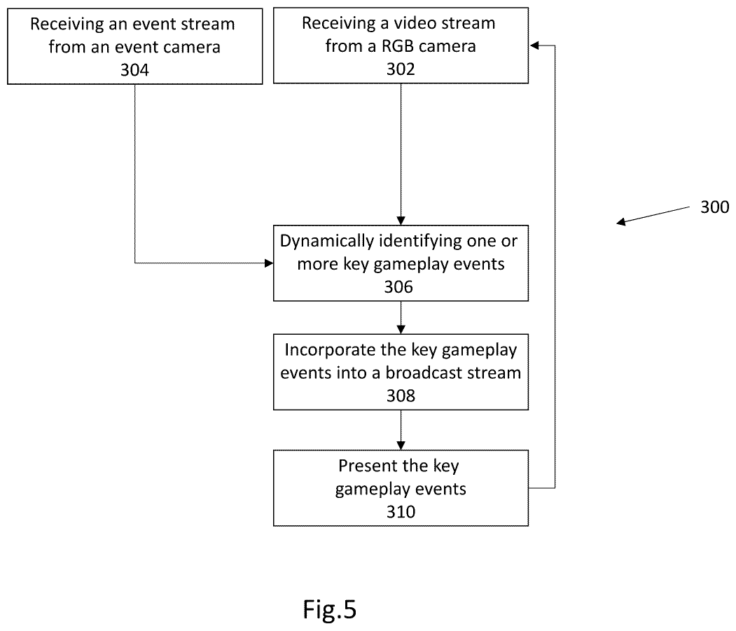

FIG. 5 illustrates a method 300 of broadcasting an esports event. FIG. 5 illustrates the workflow for esports broadcasts as applied by the directing system 200. The method 300 may be executed by elements of the system for broadcasting esports events. Step 302 comprises receiving a video stream from a RGB camera. Step 304 comprises receiving an event stream from an event camera. Steps 302 and 304 are simultaneously performed. The video stream and event stream may be simultaneously received. One or more RGB cameras and one or more event cameras of the system 100 may be adapted to capture and transmit video streams and event streams respectively simultaneously, to the directing system. In one example, the processor of the directing system 200 may be configured to simultaneously process the received video streams and the event streams.

Step 306 comprises dynamically identifying one or more key gameplay events. The one or more key gameplay events are identified based on the received events. Optionally the key gameplay events may be identified based on the received event stream and the received video stream.

The key gameplay events may be critical in game actions. In particular actions or events performed by the players that are usually missed. The RGB cameras can capture the video of the gameplay on the screen but miss player actions which are a key part of the viewing experience. Key gameplay events for example can include but are not limited to hand movements, finger movements, game controller movements and other fast actions gamers perform.

Step 308 comprises incorporating the key gameplay events into the broadcast. This can be done by cutting the to the camera feed of the camera that is capturing the key gameplay events. The directing system 200 may be configured to automatically switch to the camera that has captured the key gameplay events to improve the broadcast content and quality. Step 308 may be a manual step or optionally may be an automated step. Step 310 comprises displaying or presenting the key gameplay events on the user interface 212. Presenting the key gameplay events allows a director or producer of the esports event to manually switch camera feeds to the most appropriate camera.

The method 300 may further comprise the step of selecting the most relevant key gameplay events from the one or more gameplay events based on the event data.

In one example, the method comprises applying an algorithm specifically designed to identify and extract regions of interest (ROIs) from the received event data which optimizes the broadcast focus on key gameplay events (i.e., critical in-game moments).

In one example, the step of identifying key gameplay events comprises: identifying regions of interest (ROI) within the event stream based on the event data, performing frame reconstruction using the extracted ROI to generate one or more reconstructed frames, and cropping the reconstructed frames to focus on the ROI.

In one example, the method 300 may be used for broadcasting other performance activities other than esports events such as for example, dancing or fitness events or sports events (e.g., badminton or tennis etc.).

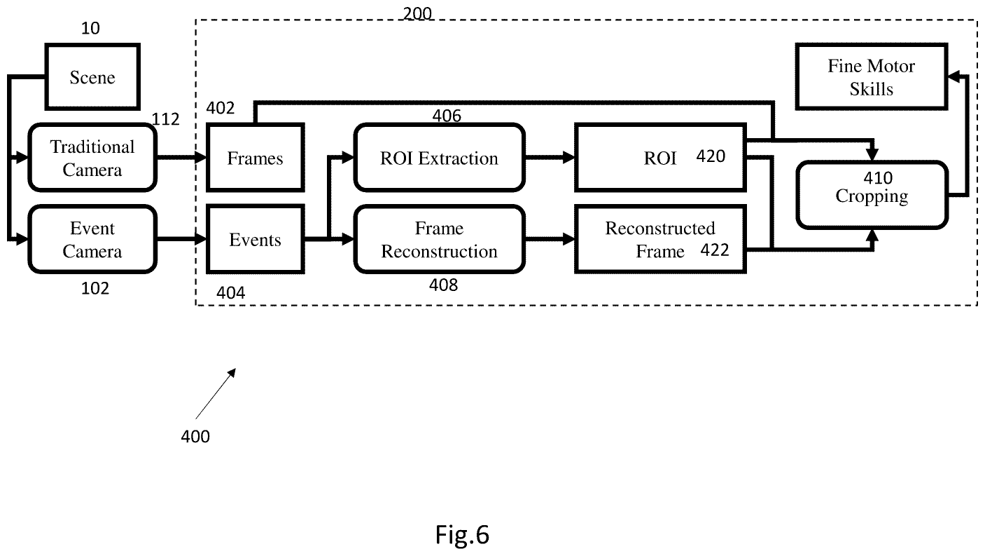

FIG. 6 illustrates a flow diagram of the workflow for a method of identifying key gameplay events. The method of identifying key gameplay events 400 is shown in FIG. 6. The method 400 is executed by the directing system 200, in particular by the processor 202 of the directing system 200.

As shown in FIG. 1 and FIG. 2, traditional frame cameras RGB cameras and event cameras are used simultaneously to record the same eSports competition scene. This dual camera setup allows us to capture comprehensive video frames and event data respectively. Traditional cameras provide a familiar frame-by-frame video sequence, while event cameras offer a stream of events that detail changes in pixel intensity at high temporal resolution.

The method 400 comprises step 402. Step 402 comprises receiving frames from a traditional camera (RGB camera) 112. Step 404 comprises receiving an event stream from the event camera 102. Steps 402 and 404 may occur simultaneously. This is because the RGB cameras and the event cameras may be adapted to simultaneously record an esports scene. The RGB cameras and the event cameras are adapted to simultaneously transmit the recorded streams to the directing system. The directing system 200 may be configured to simultaneously process the received streams (i.e., process the received video stream and event streams in parallel). The parallel processing improves processing time and broadcasting speed and quality. FIG. 6 illustrates the parallel processing.

Step 406 comprises ROI (region of interest) extraction. From the event data, ROI is extracted. The extracted ROI highlights motion or change, particularly focusing on the rapid hand movements of players. An ROI extraction algorithm is applied to identify the ROI from the event data, enabling precise focus on critical aspects of the game without the need for manual marking or intervention. As shown in FIG. 4, the extracted ROI 420 may be stored in an memory or in the database.

Step 408 comprises performing frame reconstruction. Using the extracted ROI from the event stream, intensity images are reconstructed by the processor 202. The method may be adapted to use existing reconstruction methods without relying on traditional hand-crafted priors. The resulting frames are optimized for clarity and detail, capturing nuances that traditional cameras might miss. As shown in FIG. 4, the reconstructed frames i.e., intensity images 422 may be stored in the memory unit.

Step 410 comprises cropping the reconstructed frames based on the identified ROI 420. The reconstructed frames and the traditional video frames may be accessed from a memory or database. The system 200 is adapted to apply cropping to these images based on the identified ROI. Step 410 specifically focuses on the detailed hand movements, allowing for a closer examination and display of the athletes' fine motor skills. The fine motor skills identified may be stored or may be incorporated into the broadcast or may be used to switch the camera during the broadcast. The cropped images with the identified fine motor skills may be stored in a memory unit or in the database.

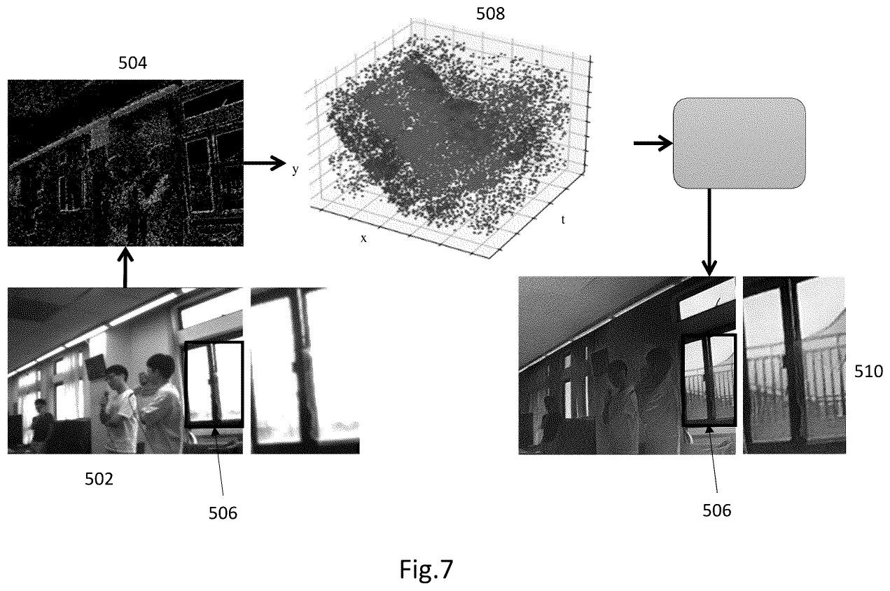

FIG. 7 illustrates a practical example of the frame reconstruction process that is used in the method for identifying key gameplay events. Referring to FIG. 7, an initial frame 502 is received and processed. An intensity image 504 is reconstructed from the ROI from the event stream. The intensity image identifies regions of the image with the highest density of events. In FIG. 7, the ROI is the window 506. The events within the ROI are 506 are plotted on a three-dimensional plot 508. A frame reconstruction process, e.g., a known frame reconstruction process may be applied to result in a reconstructed frame 510. As can be seen the image in the ROI in the reconstructed frame 510 has enhanced clarity and detail that is achieved from the event camera compared to traditional cameras.

Event cameras capture pixel changes as events, which occur when the intensity at a pixel changes. This representation is inherently different from traditional frame-based cameras and requires specialized algorithms to process. The event stream, represented as a set of tuples indicating the spatial position, time, and polarity of changes, allows for a dynamic and detailed capture of movements, crucial for analysing fast-paced eSports actions.

The event stream obtained from an event camera can be denoted as

$$ε = {\{ {e}_{i} \}}_{i = 1}^{n}$$

where n is the number of events. Here, each event
eᵢ ϵε is represented by a tuple (xᵢ, yᵢ, tᵢ, pᵢ), where x and y represent the spatial position, t represents the timestamp, and p=+−1 represents the polarity of the event. To extract ROI, firstly an event map E ϵ{0, \dot{1}}^{H×W} is constructed, where H and W denote the height and width, from the event stream by

$$E ( a , b ) = {{\sum }^{n}}_{i = 1} \{ {x}_{i} = a \} \{ {y}_{i} = b \} \vert {p}_{i} \vert , ∀ a = 1 , … , H , ∀ b = 1 , … , W , \qquad ( 1 )$$

where E(a, b) is the element on the aₜₕ row and bₜₕ column of the event map.

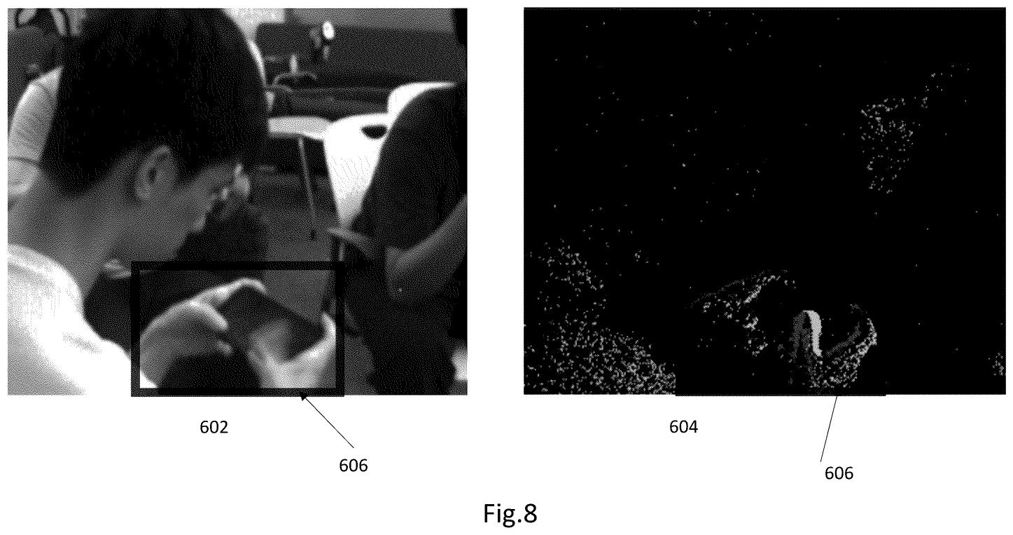

After the event map E is obtained, it is used it to facilitate directing eSports broadcasts. The key insight is that the fine motor actions of eSports athletes typically occur in areas with a high frequency of events, as illustrated in FIG. 8. The method attempts to identify sub-regions where events occur frequently.

As shown in FIG. 8, there are two images of the same frame. The image on the left 602 illustrates an RGB camera obtained image, where the blue box 606 (i.e., ROI) denotes the action of the esports athlete. The traditional camera image 602, depicted on the left, suffers from motion blur, making it challenging to discern fine details. In contrast, the event data 604, shown on the right, presents clear and distinct outlines of hand movements in the area of interest 606.

Assuming the ROI is a sub-region with expected height M and width N, the most straightforward and intuitive method would be to traverse the entire event map and compute the sum of elements within each sub-rectangle. This approach, however, would have a computational complexity of O(H*W*M*N). To improve efficiency, an algorithm that reduces the complexity to O (H*W*(M+N)) may be implemented, as depicted in Algorithm 1.

Specifically, the algorithm initially performs a horizontal scan across each row of the event map, identifying regions with the highest event density by summing up events within predefined window widths. These indices are stored for subsequent use. Following this, the algorithm evaluates vertical slices, referencing the previously stored indices to determine the most event-dense vertical sections. By segregating the analysis into horizontal and vertical components and focusing only on areas identified as having high event concentration, the process is streamlined. This method reduces the complexity from a potential O (H*W*M*N) to O (H*W*(M+N)), effectively optimizing the ability to pinpoint ROIs efficiently even in complex scenes typical of eSports environments.

Experimental observations in eSports competition scenarios reveal that typically, the vast majority of the area remains static, with only very small regions—the hands of eSports athletes—experiencing high-speed and vigorous movements that trigger a considerable number of events. The algorithm (i.e., example algorithm 1 below) is sufficiently effective and efficient in extracting the ROI for such dynamic activities.

Below is example code of Algorithm 1 that is used for ROI extraction.

Algorithm 1 Efficient Extraction of Regions of Interest (ROI)

```
Require: E, H, W, M, N [symbol]   E is the event map, H and W are the height and width of the
  the event map, respectively; M and N are the desired height and width of the ROI.
Ensure: H, W, M, N > 0
  d ←[0] [symbol]   Initialize an array to store the starting indices of the maximum sum
  subarrays for each row.
  for i ← 1 to H do
```

| | |
|---|---|
| m ← 0 | [symbol] Initialize maximum sum for the current row. |

for j ← 1 to (W − N) do

| | |
|---|---|
| s ← sum(E[i, j : (j + N)]) | [symbol] Compute sum of elements from within the iₜₕ |

```
row and the jₜₕ to (j + N)ₜₕ columns of the event map E.
    if s > m then
        m← s, d [symbol]   j
    end if
  end for
end for [symbol]   Array d now holds indices of max sum subarrays for each row.
```

| | |
|---|---|
| m ← 0 | [symbol] Reset maximum sum for column consideration. |

for i ← 1 to W do

| | |
|---|---|
| s ← 0 | [symbol] Initialize sum for current column set. |

```
for j ← 1 to (H − M) do
    for k ← i to i + N do [symbol]   Check vertical slice from jₜₕ to (j + M − 1)ₜₕ rows.
        if (d[j] ≤ k ≤ d[j] + M) then
```

| | |
|---|---|
| s ← s + 1 | [symbol] Increment count if column i within the max sum range |

```
for row k.
        end if
      end for
      if s > m then
        m ← s, T ← j, y ← i [symbol]   Update maximum and store top-left corner of ROI.
```

```
    end if
    end for
end for
```

| | |
|---|---|
| return x, y | [symbol] Return indices x, y as the top-left corner of the extracted ROI. |

The inventors tested the system and method for broadcasting. The inventors captured the entirety of an eSports competition and established a dataset from the recordings. The details of the equipment used are outlined in Table 2. The resultant dataset, as described in Table 3, comprises extensive video and event data across various gaming scenes. This dataset is structured to facilitate detailed analysis and algorithm testing, aimed at enhancing the broadcast quality and viewer experience of eSports competitions.

TABLE 2
Specifications of the event camera DAVIS 346, which
is a 346 × 260 pixels event camera with included
active pixel frame sensor [1].

| | | |
|---|---|---|
| DVS Resolution | 346 × 260 | pixels |
| Frame Resolution | 346 × 260 | pixels |
| DVS Dynamic range | 120 | dB |
| APS Dynamic range | 56.7 | dB |
| Min. latency | \tilde{2}0 | us |

| | |
|---|---|
| Lens mount | CS-mount |
| Connectors / Power | USB 3.0 micro |
| Bandwidth | 12 MEvents / second |
| Software | DV-Platform |
| Power consumption | <180 mA @ 5 V DC |

TABLE 3
Dataset statistics providing an overview of the volume and distribution
of frames and event data captured during the eSports competition,
illustrating the comprehensive nature of the data collection.

| | |
|---|---|
| Number of scenes | 40 |
| Total number of frames | 46,491 |
| Average frame number per scene | 1,162 |
| Minimum frame number of a scene | 33 |
| Medium frame number of a scene | 947 |
| Maximum frame number of a scene | 5474 |
| Total number of events | 779,002,043 |
| Average event number per scene | 19,475,051 |
| Minimum event number of a scene | 46,509 |
| Medium event number of a scene | 11,173,012 |
| Maximum event number of a scene | 100,966,145 |

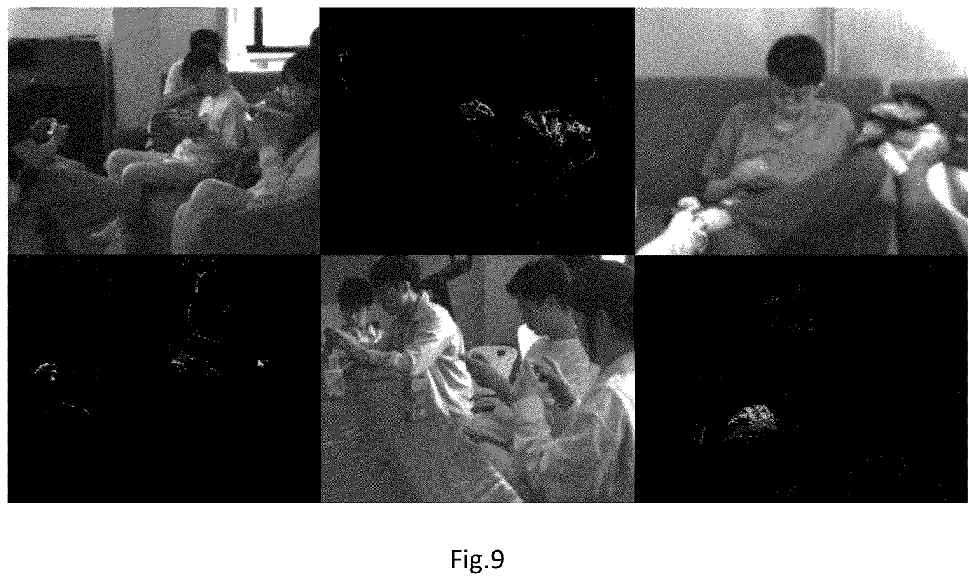

With 40 different scenes, the dataset includes a high number of frames (over 46 thousand) and events (over 779 million). Moreover, the dataset provides a wide range of scenarios featuring varying degrees of motion intensity and lighting conditions. For example, three different esports scenes from the dataset are illustrated in FIG. 9. The images from RGB cameras and events from event cameras may be stored. This extensive collection allows for detailed investigations into the temporal dynamics of scenes. Moreover, the dataset provides a widerange of scenarios featuring varying degrees of motion intensity and lighting conditions.

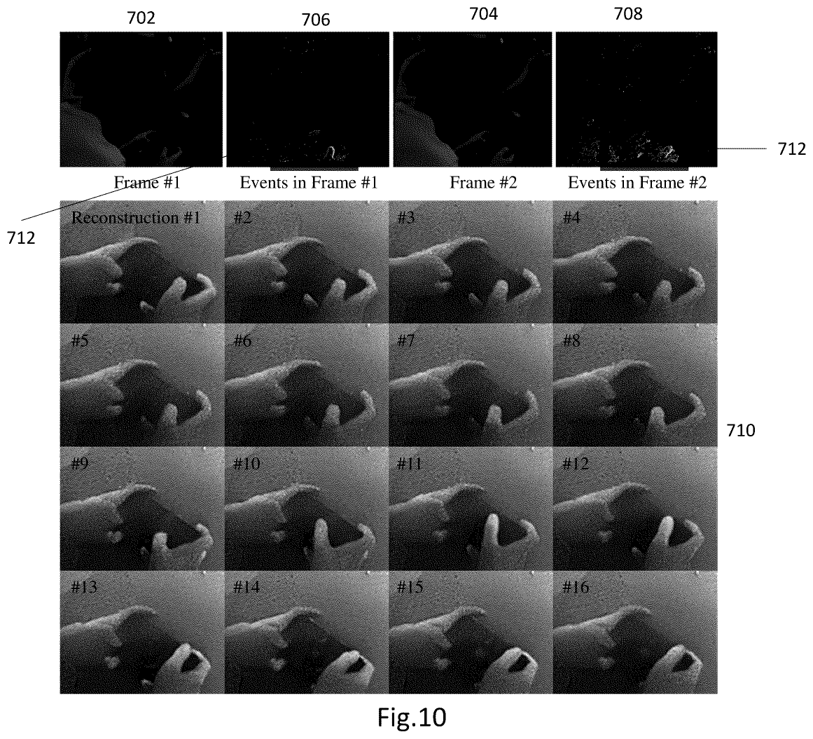

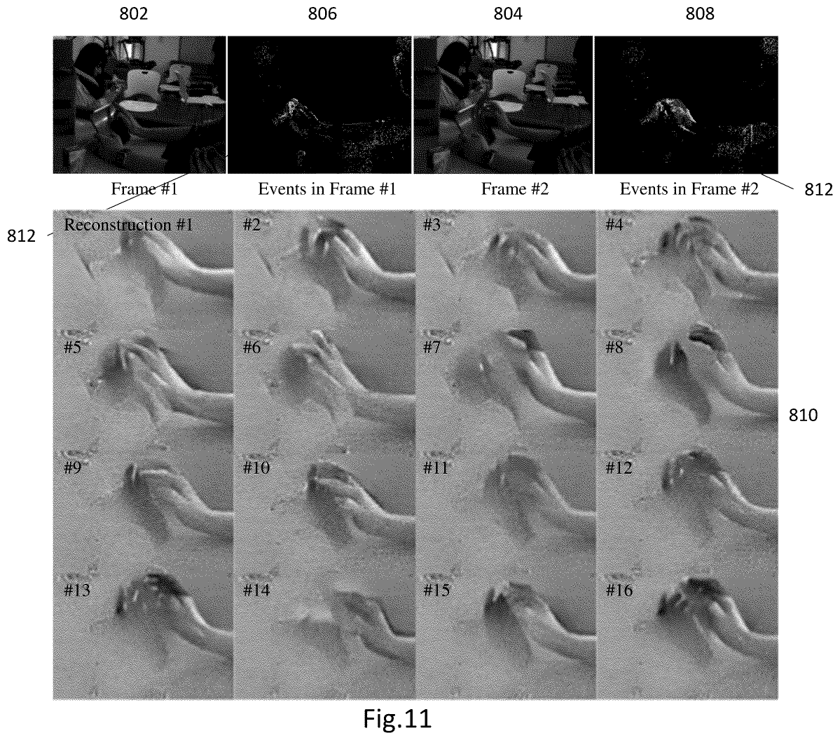

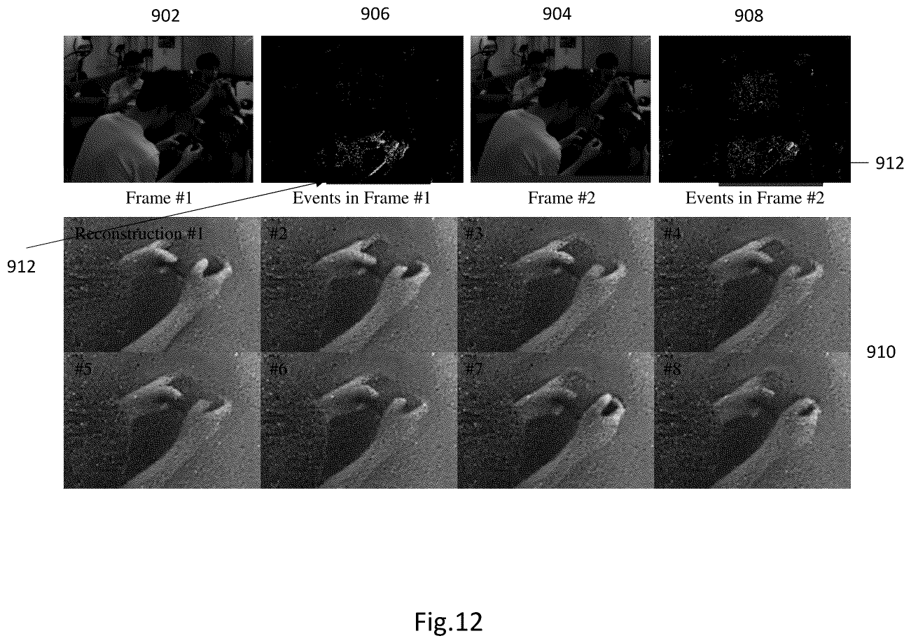

FIGS. 10, 11 and 12 illustrate enhancements across the scenes showing improved broadcasting quality. The illustrated drawings in FIGS. 10 to 12 show the effectiveness of the described system and method for broadcasting esports. FIG. 10, FIG. 11 and FIG. 12 illustrate the reconstructed frames and improvement in clarity and quality due to reconstructions.

In FIG. 10, the reconstructions allow viewers to perceive subtle hand gestures and rapid movements in a more stabilized and clear format. Similarly, FIGS. 11 and 12 illustrate how the fast motions are more accurately represented through the event-based frame reconstructions. The ability to improve eSports broadcasts through such reconstructions is evident from the comparison between the original frames and the reconstructed sequences. FIGS. 10 to 12 illustrate results of testing the method of broadcasting esports, in particular the method of identifying key gameplay events. FIGS. 10 to 12 illustrate the result of testing the method 400.

Referring to FIG. 10, two frames 702, 704 are captured, and their corresponding events 706, 708 are shown. Reconstructed frames 710 are illustrated. Temporal resolution and dynamic range achieved through the reconstruction of frames from event streams in an esports context. The ROI is shown as the rectangle 712.

Referring to FIG. 11, the two original frames 802, 804 are captured by RGB cameras, and events 806, 808 are captured by the event cameras. Reconstructed frames 810 are illustrated. The reconstructed frames have improved temporal resolution and dynamic range. The ROI is the highlighted rectangle 812.

Referring to FIG. 12, the reconstructed frames 910 show an improvement over the original frames 902, 904. The reconstructed frames are created from the event data 906, 908, and the ROI is the rectangle 912.

The outputs of the tests, as shown in FIGS. 10 to 12 illustrate a marked improvement in resolution and clarity. This shows the described system and method improve the identification key gameplay events such as fine motor movements, finger movements, hand movements etc. Use of these improved images in the broadcast improves the quality and engagement of the broadcast and provides viewers with a new insight into esports.

The original frames, while providing a base reference, often suffer from a lack of detail in fast-moving objects or in areas with complex lighting. The reconstructed frames, processed from event data, showcase a marked improvement in both clarity and exposure, making them superior for broadcast purposes.

Therefore, the testing confirms that utilizing reconstructed frames from event streams can substantially elevate the broadcasting standards for eSports. This approach (i.e., the approach described herein) not only enhances the visual quality by optimizing temporal resolution and dynamic range but also offers a new way to engage with dynamic sports content, promising a more immersive and detailed viewing experience for audiences.

The inventors conducted a further user study to validate the efficacy of the described system and method, and in particular the advantages of using event cameras in esports broadcasting. This study aimed to assess viewer preferences regarding the output from traditional video frames compared to event-based reconstructed frames.

A survey questionnaire was designed by the inventors, where participants were shown video clips from the inventors stored dataset, featuring scenes captured by both traditional cameras and event cameras. Participants were asked to evaluate and compare these clips based on three key criteria: (1) temporal resolution, (2) dynamic range, and (3) motion clarity. Additionally, a hypothetical scenario was posed to participants: if they were watching a live eSports match with an option to choose between different camera feeds, which would they prefer? The choices were (a) only traditional camera output, (b) only event camera output, and (c) a combined view of both traditional and event camera outputs. The survey was distributed online and garnered 32 responses. The results, as tabulated in Tables 4 and 5, shown below.

TABLE 4
User preferences between traditional and event cameras across
three criteria: (1) temporal resolution, (2) dynamic range,
and (3) motion clarity, illustrating a strong inclination
towards the capabilities of event cameras.

| Fine Motor | with traditional | with an event |
|---|---|---|
| Skills | a camera | camera |
| Temporal resolution | 9.4% | 90.6% |
| Dynamic range | 3.4% | 96.6% |
| Motion Clarity | 6.9% | 93.1% |

TABLE 5
User preferences for different viewing setups during
an eSports broadcast, highlighting the interest in combining
feeds from both traditional and event cameras.

| Setup | Preference |
|---|---|
| Only a traditional camera | 6.9% |
| Only an event camera | 41.4% |
| Traditional camera + | 51.7% |
| event camera | |

From the responses, a significant preference for event camera outputs was noted in all three assessed categories, as shown in Table 4. For temporal resolution, 90.6% favoured the event camera, suggesting a strong viewer preference for the higher frame rates and reduced motion blur provided by event technology. Similarly, 96.6% preferred the event camera for its superior dynamic range, which is crucial in handling the varied lighting conditions of eSports venues. Motion clarity also saw a high preference for event cameras at 93.1%, underscoring the ability to capture finer details that are typically missed by traditional cameras.

In terms of viewing setup preferences as shown in Table 5, while 41.4% of participants chose to view content solely from event cameras, a notable 51.7% preferred a combined setup of both traditional and event cameras. This suggests that while the enhanced capabilities of event cameras are recognized, viewers still value the perspective offered by traditional cameras, indicating a complementary relationship between the two technologies in broadcasting.

The present disclosure improves upon existing sports broadcasting systems by using event cameras that capture more detailed and dynamic visual content, setting a new standard in the industry. Key advantages include reduced motion blur, enhanced dynamic range, and the ability to capture intricate motor skills of eSports athletes with remarkable clarity. Additionally, the automated, real-time directing capability represents a significant advancement over traditional methods, enhancing operational efficiency and viewer engagement.

Using event cameras for eSports broadcasts provides the advantage of enhancing temporal resolution, dynamic range, and motion clarity against traditional ones. By capturing the subtle and rapid movements of eSports athletes more accurately, event cameras not only improve the viewing experience but also offer potential for advanced analytics and training tools in eSports.

The system for broadcasting an esports event as described herein may be used to broadcast an esports event. However, the system and its components as described may be used to broadcast performance activities such as an esports event. Alternatively, the system and its components as described may be used to broadcast other performance activities (e.g, non esports activities) such as, for example, action, drama, dancing, fitness events, sports events etc. The system 100 may be a system for broadcasting a performance activity. Such activity may include various sports, games, drama, arts or any action, manipulation, pose, sequence of actions or motion related activities, including acting, wrestling, martial arts, boxing, dancing, sports, racket sports, track and field, swimming, fencing, shooting, archery, golf, cross training, gymnastics, chess, etc. Some specific implementation examples, may include, without limitation:

### Running

In one example, the performance activity event is a running event. An event camera is mounted track-side to capture the runner's limb motions as asynchronous brightness changes. The directing system receives the event stream and constructs an event map in real-time. It identifies a region of interest (ROI) corresponding to the runner's foot strikes and leg swings by summing events within a sliding time window and clustering high-density regions. The processor reconstructs cropped intensity frames for the ROI, highlighting precise foot placement and joint articulation without motion blur. The directing system then incorporates these reconstructed frames into the broadcast stream-automatically switching to close-up views of the runner's gait cycle for enhanced viewer analysis of running form.

### Dancing

In one example, the performance activity event is a dance performance. Event cameras focus on the dancer's torso and limbs, capturing subtle pose transitions and rapid arm movements as event data. The directing system builds multi-scale event heatmaps (e.g., 10 ms, 50 ms windows) and applies a horizontal-vertical scan algorithm to extract ROIs around hands, feet, and hip motions. Reconstructed frames from these ROIs preserve the fluidity and timing of choreography. The system presents key dance poses to the user interface, and may automatically switch between full-stage RGB feeds and cropped event-based reconstructions to emphasize artistic highlights.

### Badminton

In one example, the performance activity event is a badminton match. An event camera is mounted above the court to capture the high-speed shuttlecock and racket swings as asynchronous brightness changes. The directing system receives the event stream and constructs sliding-window event heatmaps (e.g., 5 ms and 20 ms windows). It then applies density-based clustering to detect ROIs around shuttlecock impacts and racket contacts. The processor reconstructs cropped intensity frames for these ROIs, preserving the sharpness and timing of smashes and drop shots. The directing system integrates these focused reconstructions into the broadcast feed-automatically cueing close-up replays of critical rallies to enhance viewer insight.

### Tennis

In one example, the performance activity event is a tennis match. An event camera is positioned near the baseline to capture rapid ball exchanges and player footwork. The directing system processes the incoming events to generate spatiotemporal clusters, identifying ROIs at moments of ball-racket impacts and player serve motions. Using adaptive threshold segmentation, it localizes these ROIs in real time. The processor then reconstructs high-fidelity frames of serves, volleys, and net play with minimal motion blur. These reconstructed frames are dynamically inserted into the live broadcast, automatically switching to high-detail replays of key points for improved spectator engagement and tactical analysis.

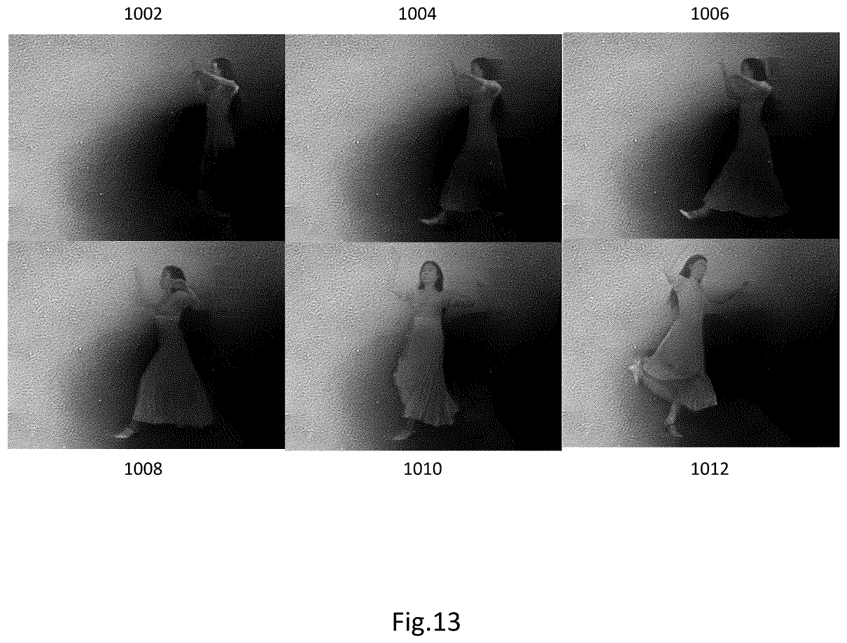

FIG. 13 illustrates example reconstructed frames of a dancing event captured using the event cameras and RGB cameras. The reconstructed frames illustrate the key movements or events within the dance performed by the person. Frames 1002 to 1012 illustrate key dance actions i.e., key dance events. These events may be defined as ROI (regions of interest). The frames may be reconstructed by applying the method for broadcasting 300. The method steps may be applied to captured images of a performance activity e.g., dancing. The system 100 and its components may be used for broadcasting a performance activity e.g., dancing as shown in FIG. 13. The directing system as described herein may be implemented for directing a broadcast of a performance activity. The directing system may be implemented for directing broadcast of a performance activity e.g., dancing or other performance activities other than esports such as for example, fitness, sports etc. Similar advantages as described e.g., reducing motion blur, enhanced dynamic range and the ability to capture intricate motor skills with clarity also apply when the system and method are used for broadcasting a performance activity other than esports. The directing system as described further is advantageous because it provides operational efficiency and viewer engagement.

The system and method for broadcasting an esports event (or for broadcasting a performance activity) may also be advantageous because the data captured is smaller in size. This reduced the bandwidth requirements for broadcasting as the use of event cameras allows for capturing rapid and subtle movements of a person e.g., an esports player or person doing a performance activity. The method is advantageous because regions of interest from high temporal resolution event streams are extracted over the conventional manual selection methods used in traditional broadcasting. This improves the speed of broadcast, and can reduce the bandwidth requirements. The system and method for broadcasting enhances the quality and interactive experience of broadcasts.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present disclosure are either wholly implemented by computing system or partly implemented by computing systems then any appropriate computing system architecture may be utilised. This will include stand-alone computers, network computers and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the specific embodiments as described. The present embodiments are, therefore, to be considered in all respects as illustrative and not restrictive.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc., in a computer program. When a process corresponds to a function, its termination corresponds to a return of the function to the calling function or a main function.

Aspects of the systems and methods described above, such as for example the directing system 200 may be operable on any type of general purpose computer system or computing device, including, but not limited to, a desktop, laptop, notebook, tablet, smart television, gaming console, or mobile device. The term “mobile device” includes, but is not limited to, a wireless device, a mobile phone, a smart phone, a mobile communication device, a user communication device, personal digital assistant, mobile hand-held computer, a laptop computer, wearable electronic devices such as smart watches and head-mounted devices, an electronic book reader and reading devices capable of reading electronic contents and/or other types of mobile devices typically carried by individuals and/or having some form of communication capabilities (e.g., wireless, infrared, short-range radio, cellular etc.).

Aspects of the systems and methods described above may be operable or implemented on any type of specific-purpose or special computer, or any machine or computer or server or electronic device with a microprocessor, processor, microcontroller, programmable controller, or the like, or a cloud-based platform or other network of processors and/or servers, whether local or remote, or any combination of such devices.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

In its various aspects, embodiments of the described system and method can be embodied in a computer-implemented process, a machine (such as an electronic device, or a general-purpose computer or other device that provides a platform on which computer programs can be executed), processes performed by these machines, or an article of manufacture.

This disclosure may also be said broadly to consist in the parts, elements and features referred to or indicated in this disclosure, individually or collectively, and any or all combinations of any two or more said parts, elements or features, and where specific integers are mentioned herein which have known equivalents in the art to which this disclosure relates, such known equivalents are deemed to be incorporated herein as if individually set forth.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

The scope of the present disclosure is not intended to be limited by the specific disclosures of embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Any reference to prior art contained herein is not to be taken as an admission that the information is common general knowledge, unless otherwise indicated.

We claim:

1. A system for broadcasting a performance activity comprising:
at least one event camera focusing on a performance activity scene within performance activity event,
wherein the at least one event camera is adapted to capture event data related to the performance activity scene and transmit an event stream comprising the event data,
a directing system comprising a processor, a memory unit operatively coupled to the processor, and a user interface operatively coupled to the processor,
the at least one event camera is adapted to communicate with the directing system, wherein the directing system is configured to:
receive the event stream comprising the captured event data from the at least one event camera,
the processor is configured to dynamically identify one or more key gameplay events based on the captured event data, and,
present the one or more key gameplay events on the user interface.

2. The system of claim 1 comprising at least one RGB camera and at least one event camera focusing on the performance activity scene,
wherein the at least one RGB camera is adapted to record a video stream of the performance activity scene, wherein the video stream comprises multiple frames of the performance activity scene and,
the RGB camera further adapted to transmit a video stream comprising the captured frames to the directing system.

3. The system of claim 1 comprising a plurality of RGB cameras and a plurality of event cameras, wherein each RGB camera comprises at least one event camera being mounted on a RGB camera.

4. The system of claim 2 wherein the performance activity is an esports event and the performance activity scene is an esports event scene,
wherein directing system is further configured to automatically select the most relevant key gameplay events from the one or more gameplay events based on the event data.

5. The system of claim 4 wherein to identify key gameplay events the directing system is configured to:
identify regions of interest (ROI) within the event stream based on the event data,
perform frame reconstruction using the extracted ROI to generate one or more reconstructed frames, and;
crop the reconstructed frames to focus on the ROI.

6. The system of claim 5 wherein the ROI is related to hand or finger movements of an esports athlete in the esports event.

7. The system of claim 5 wherein to identify ROI, the directing system is configured to:
construct or extract an event map from the received event data,
identify regions of highest event density within the event map by summing events within predefined windows,
wherein the identified regions of highest event density correspond to the ROI.

8. The system of claim 7, wherein to identify regions of highest event density the directing system is further configured to:
perform a horizontal scan across each row of the event map,
identify regions with the highest event density by summing events within predefined window widths,
store the indices of the rows with the highest event density,
evaluate vertical slices or columns of the event map corresponding to the stored indices,
determine the columns or vertical slices having the highest event density,
identify an ROI that corresponds to a horizontal window and a vertical slice or column that comprise the highest event density.

9. The system of claim 4 wherein the directing system is configured to broadcast a stream of the esports event wherein the stream wherein the stream automatically switches between multiple RGB camera streams and the most relevant key gameplay events.

10. The system of claim 9 wherein the directing system is configured to:
present the cropped frame focusing on the ROI on the user interface and/or,
generate a stream of the esports event and switch the stream to focus on the ROI.

11. A system for broadcasting an esports event comprising:
at least one event camera focusing on an esports scene within an esports event, wherein the at least one event camera is adapted to capture event data related to the esports scene and transmit an event stream comprising the event data,
at least one RGB camera and at least one event camera focusing on the esports scene, wherein the at least one RGB camera is adapted to record a video stream of the esports scene, wherein the video stream comprises multiple frames of the esports scene and,
a switcher operatively coupled to the at least one event camera and the at least one RGB camera and the at least one event camera,
a directing system comprising a processor, a memory unit operatively coupled to the processor, and a user interface operatively coupled to the processor, the at least one event camera is adapted to communicate with the directing system,
the directing system is further operatively coupled to the switcher and configured to control the switcher,
wherein the directing system is configured to:
receive the event stream comprising the captured event data from the at least one event camera,
receive captured video including a plurality of captured frames from the at least one RGB camera,
the processor is configured to dynamically identify one or more key gameplay events based on the captured event data,
generate a broadcast stream comprising the video stream from the at least one RGB camera and/or the event data from the at least one event camera, and;
control the switcher to switch to a RGB camera and/or event camera that corresponds to the identified key gameplay events such that the broadcast stream is focused on the identified key gameplay events.

12. The system of claim 11 wherein directing system is configured to present the one or more key gameplay events on the user interface.

13. A computer-implemented method for broadcasting an esports event, comprising the steps of:
receiving an event stream comprising a captured event data from at least one event camera,
receiving a recorded video stream from at least one RGB camera, wherein the video stream comprises multiple frames of the esports scene,
dynamically identifying one or more key gameplay events based on the captured event data, and,
presenting the one or more key gameplay events on the user interface.

14. The method of claim 13 comprising the step of receiving video streams from a plurality of RGB cameras and event streams from a plurality of event cameras, wherein each RGB camera comprises at least one event camera being mounted on a RGB camera.

15. The method of claim 14, wherein the step of receiving the event stream and receiving the RGB stream may occur simultaneously, and; wherein the at least one RGB camera and the at least one event camera may simultaneously record and transmit streams of an esports scene.

16. The method of claim 14, wherein the method comprising automatically selecting the most relevant key gameplay events from the one or more gameplay events based on the event data, w
wherein the step of identifying key gameplay events comprising:
identifying regions of interest (ROI) within the event stream based on the event data,
performing frame reconstruction using the extracted ROI to generate one or more reconstructed frames, and,
cropping the reconstructed frames to focus on the ROI.

17. The method of claim 15 wherein the step of identifying ROI comprising:
constructing or extracting an event map from the received event data,
identifying regions of highest event density within the event map by summing events within predefined windows,
wherein the identified regions of highest event density correspond to the ROI.

18. The method of claim 17 wherein the step of identifying regions of highest event density comprising:
performing a horizontal scan across each row of the event map,
identifying regions with the highest event density by summing events within predefined window widths,
storing the indices of the rows with the highest event density,
evaluating vertical slices or columns of the event map corresponding to the stored indices,
determining the columns or vertical slices having the highest event density, and
identifying an ROI that corresponds to a horizontal window and a vertical slice or column that comprise the highest event density.

19. The method of claim 18 comprising broadcasting a stream of the esports event, and; automatically switching between multiple RGB camera streams and the most relevant key gameplay events.

20. The method of claim 19 comprising the steps of:
presenting the cropped frame focusing on the ROI on the user interface and/or,
generating a stream of the esports event and switch the stream to focus on the ROI.
